(19) United States
(12) Patent Application Publication
(10) Pub. No.: US 2003/0197060 A1
(43) Pub. Date: Oct. 23, 2003

(54) Consumer-focused gallon-based prepaid gasoline card, system and method for a car drivers

(76) Inventor: Vince Coyner, Atlanta, GA (US)

Correspondence Address: CROWELL & MORING LLP, INTELLECTUAL PROPERTY GROUP, P.O. BOX 14300, WASHINGTON, DC, 20044-4300, US

(21) Appl. No.: 10/310,972

(22) Filed: Dec. 6, 2002

Related U.S. Application Data
(60) Provisional application No. 60/337,995, filed on Dec. 6, 2001.
(60) Provisional application No. 60/401,287, filed on Aug. 6, 2002.

(51) Int. Cl. G06F 7/08

(52) U.S. Cl. 235/381

(57) ABSTRACT

A medium with readable data is provided to be ready by a reader/scanner in order to identify an amount of prepaid/pre-purchased gasoline in gallons. A system and method of selling or purchasing he gasoline uses a computer system with a database holding the amount of gasoline whereby the dispensed amount of gasoline to a consumer is identified and subtracted from the prepaid-pre-purchased amount in gallons.

This application claims the priority of U.S. Provisional Application Nos. 60/337,995 and 60/401,287 filed on Dec. 6, 2001 and Aug. 6, 2002, entitled “A Gallon-Based Prepaid Gasoline Card, System and Method” and “A Consumer Focused Gallon-Based Prepaid Gasoline Card, System and Method for Car Drivers, respectively, the disclosures of which are expressly incorporated by reference herein.

### BACKGROUND AND SUMMARY OF THE INVENTION

This invention relates to a prepaid gasoline card system and method in which a consumer may prepay for future consumption of gasoline.

It is known that gasoline retailers use credit-card-type cards and so-called speed passes for key rings which allow consumers to quickly be identified at a dispensing or gasoline pump and then take delivery of gasoline with their account debited. These types of systems only allow a consumer to purchase or dispense gasoline at a current retail price. Even if an account is set with a fixed monetary value, the consumer, retailer, or wholesaler cannot hedge or gauge future gasoline price swings based on this system.

An aspect of this invention is to provide a system in which a consumer can prepay for gasoline based on gallons. This would allow a consumer, retailer and/or wholesaler to gauge an amount of gasoline to be purchased instead of a monetary value of gasoline to be purchased.

This aspect may be achieved by certain preferred embodiments of the invention in that a prepaid gallon-based gasoline system includes a medium with readable data. A reader operates to read the readable data, and a computer system operates to analyze the readable data and identify a remaining amount of gallons of gasoline associated with the readable data. The computer system operatively identifies a distributed amount of gallons of gasoline distributed to the consumer of the distributed gasoline during one use. The computer system can then decrement the remaining amount of gallons of gasoline associated with the readable data by the distributed amount of gallons of gasoline. The consumer having paid a predetermined posted price per gallon for the gasoline when originally purchased.

The medium used in conjunction with the readable data may be a card (i.e., credit card type); a magnetic strip, preferably based on a card; a barcode strip; an electronic chip preferably associated with a card; a radio-wave readable medium—such as an electronically enhanced key ring; fingerprints, retinas, personal digital assistance (PDA); and/or a mobile telephone.

The readable data on the medium can be an amount of gasoline in gallons which remains on the card or which is originally purchased. The readable data may also or in the alternative be an ID code particular to the consumer or medium, an authentication, a validation, or/and some other data which is tied to the amount of gasoline in gallons for the card. The readable data may also simply be the raised numbers, or the like, identified on the card.

The reader can be a conventional reader/scanner associated with current gasoline pumps. The reader may also be a reader/scanner associated with one of the types of mediums listed above. The reader reads the readable data in order to transfer the readable data to a computer system. The reader may also operate to write on the medium, such as writing the remaining amount of gallons of gasoline for the medium, or account as reflected by the reduced amount of dispensed gasoline. Other purchase or identification data may also be written to the medium.

The computer system communicates with the reader in order to acquire the read data. The computer system may hold a central database which includes accounts associated with the readable data. The computer system can then identify the account being used by the readable data and, in turn, subtract the amount of dispensed gasoline from the amount in gallons of prepaid gasoline associated with the readable data.

In another embodiment, the invention includes a method of purchasing gasoline and a method of selling gasoline. In a method of purchasing gasoline, a consumer or third party purchases a number of gallons of gasoline based on a posted predetermined price. The price of the pre-purchased or prepaid gasoline may be the current retail price during the purchase or a discounted or marked-up price. Upon purchase, a medium having a readable data is associated with the number of gallons of gasoline purchased. The medium is readable by a reader to identify the readable data. Data relating to the purchase is stored in a computer system so that the readable data identifies the number of gallons of gasoline purchased via the computer system and allows an amount of gasoline to be dispensed when the medium is used to acquire gasoline. The computer system operates to subtract the amount of gasoline dispensed in gallons from the number of gallons of gasoline purchased and newly associate the readable data or re-write the readable data to reflect the subtraction.

In a method of selling gasoline, a retailer or wholesaler reads a medium having readable data via a reader. The readable data is identified from a database via a computer system. A number of gallons of gasoline is associated with the readable data. The number of gallons of gasoline is pre-purchased. Upon this, an amount of gasoline is dispensed to the consumer. The amount of gasoline dispensed is then associated with the readable data. The amount of gasoline dispensed is subtracted from the number of gallons which are pre-purchased to obtain a remaining number of gallons of gasoline. The new number of gallons of gasoline is then associated with the readable data, or the readable data is re-written to reflect the new number of gallons of gasoline.

Under such a method and/or system, a retailer dispensing the gasoline may receive a known monetary value for the gasoline dispensed. This known value may be the current price of the gasoline if another party transacts with the consumer originally, thus letting the other party ledge liabilities, or it may be the price of the originally purchased gasoline if their wholesaler or company transacts originally with the consumer. An agreement between the original seller and subsequent dispensers may also provide variations in the monetary value received by the dispenser.

Other objects, advantages and novel features of the present invention will become apparent from the following detailed description of the invention when considered in conjunction with the accompanying drawings.

### BRIEF DESCRIPTION OF THE DRAWING

FIG. 1 shows a diagrammatic flow of the system and method.

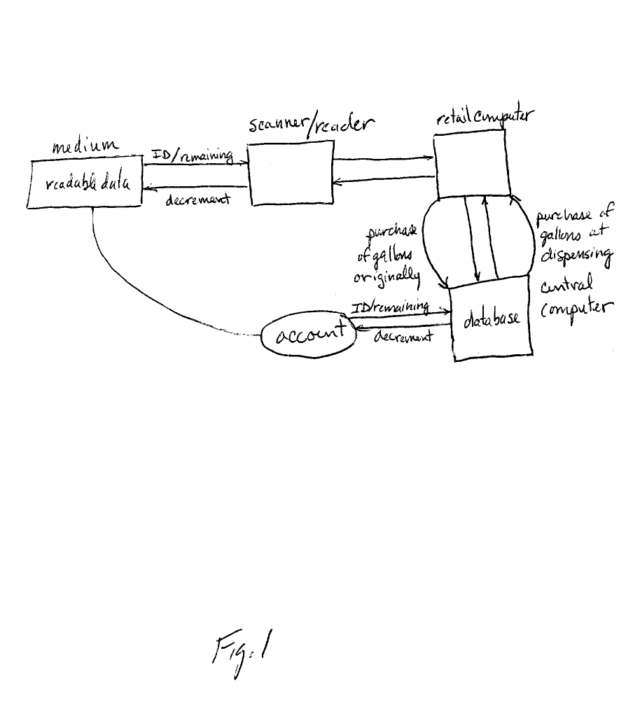

### DETAILED DESCRIPTION OF THE INVENTION

A consumer focused gallon-based prepaid gasoline card which is used to allow a consumer to pay a specific amount for a specific number of gallons of automobile gasoline which can be redeemed at any time in the future, within the parameters of the purchase agreement (i.e. there may be a 3-24 or more month life of the card), regardless of the future on then current price of gasoline. The price to be paid by the consumer for the gas is determined at the time the card is sold and is, by definition of the transaction taking place, agreed to by both parties. A bidding system is not encompassed by such a transaction or determined price (predetermined price at the time of the gallons being dispensed). The price may be the current posted retail price of a gallon of gasoline, the retail price plus a predetermined markup amount (example: today's price plus/minus 5%) or some other predetermined method of pricing the retailer (or wholesaler) might set. The predetermined price of the gallons when dispensed is thus the posted price or a derivative of the posted price.

The card's value is tied to gallons of gasoline as opposed to a specific dollar amount. The number of gallons is either pre-determined (a pre-printed 50-gallon card) or specified at the time of purchase, (i.e. a card that is encoded to record the purchase of 65 gallons of gasoline). The card indicates the number of gallons purchased as part of the transaction (via the card's number, its magnetic strip or a data chip). The purchaser will then utilize the card's stored value to redeem the appropriate number of gallons of-gasoline at any time in the future (within the parameters of the contract) regardless of the posted price of gasoline. Each card will have a value in gallons and a corresponding account through which the retailer is paid. When the customer uses the card to take delivery of gas, the card and its account are debited by the appropriate number of gallons. The payment account is valued in dollars, but it tracks the number of gallons redeemed. For accounting purposes—i.e., if the purchaser wants a refund on the remainder of the card's value—the card will maintain a corresponding remaining dollar value of the card tied to the dollar amount paid for or added to the card. In another embodiment, the card registers (subtracts) the number of gallons purchased rather than a specific dollar amount.

The retailer may or may not allow the purchaser to add value (gallons) to their card at any time. The price of the gallons of gasoline added to any card will be tied to the current price set by the retailer (or wholesaler) at the time the customer seeks to add value to their card. (i.e., at the time of the initial purchase the retail price per gallon may have been $1.00 per gallon and the customer purchased 100 gallons for $100. Six months later, when the price has risen and the customer would like to add 100 gallons to their card, the cost is $125. The card, assuming it had never been used by the consumer, would then hold 200 gallons of gas for which the customer had paid $225).

Data is used to indicate the card's status such as its authenticity, its validity, its current stored value and what station(s) or retailer(s) where it can be used to redeem gasoline. The data is either stored on the card or in a system database tied to the card's identification number or a combination of the two. In addition to the information about the card's value, validity and authenticity, there is a provision for the data to record the card's purchase history, its owner, any authenticity, any affiliations (i.e., for group discounts, benefits or membership rewards) or other data that will allow the retailer to provide better or additional services to that customer in particular or customers in general, or provide them more profitably. A chip may be used to sore readable data including a complete transaction history and parameters along with remaining gallons.

This gallon-based prepaid gasoline card system is used in conjunction with a data reading/card scanning machine that reads the numbers from the card (or the data stored on a chip on the card or its magnetic strip). This system and the data from each card is utilized by the gasoline retailer when the card is used to take delivery of the gasoline that has been purchased. This allows the retailer (or the dispensing machines or pumps) to know how much value is on or remains on the card—number of gallons of gasoline and the corresponding dollar value. When the customer uses the card to take delivery of the gallons of gasoline, the data reading/card scanning machine reads the data from the card to determine whatever its current value is. Once the transaction is finished the system then decrements the value of the card to reflect the gallons redeemed during the transaction. (i.e., the customer has a 100 gallon card, fills up their vehicle with 20 gallons of gasoline and uses the card as method of payment. The system decrements the value of the card so that it now holds 80 gallons of gas.) Once the value of the card is read by the data reading/card scanning machine, this data may be used to limit the number of gallons of gas the customer can take delivery of with that card. (I.e., if the card has 11.5 gallons of remaining value, the pump may be set to stop dispensing at 11.5 gallons, thus forcing the customer to pay for the remainder of their fill-up at the current price.)

This consumer focused gallon-based prepaid gasoline card system, along with its data reading/card-scanning machines may be tied into a central database that records all transactions and the value of each card. This allows for a real-time assessment of the value of each card as well as allows the seller of the cards to know what their current liabilities are in relation to the aggregate number of cards in circulation. This system can also be used in conjunction with its corresponding purchase management software which allows retailers, wholesalers and others involved in this system to gauge and hedge the level of their liability in terms of gallons of gas that may be consumed by card holders. This software system may note the price paid for each gallon stored on each card and in aggregate, will predict the timetable for redemption or usage of the cards and suggest the most efficient and effective manner in which to ensure profitable delivery of the required gallons. This allows the involved parties to buy; sell or trade gasoline features to further predictability and leisure liability.

These cards may have a finite life such as 6 months, 18 months or 2 years after they have been purchased.

This card system may have as one of its components software that gives gas pumps and other gasoline tracking machines the ability to translate the value of the card's stored value into its current tracking system. This would allow a pump which typically tracks a purchase according to dollars to be able to convert the tracking such that it can track the number of gallons pumped and decrement the card's (or the associated account's) value a corresponding number of gallons. This software will at the same time be written in such a way that it can be utilized by future pump and machine OEMs to allow for transactions with these gallon-based prepaid gasoline cards.

This system may also include a feature where the receipt for the gasoline paid for from the stored value of this card shows how much the customer saved, i.e., if the customer paid $100 for 100.

You paid $20 for 20 gallons of gasoline today;

The retail value of that gasoline was $33;

You saved $13 or 40% on your gasoline today!

This system may also include sponsorship by third parties that wish to brand these cards with their names. Cards may be tied to promotions, incentives, gifts, rewards or other methods in which an organization, group or individual may want to market their offerings in conjunction with the retailers who accept these cards.

These cards may also be developed in conjunction with existing payment cards and value storage card issuers so that they may be issued as part of a current payment system. This development cooperation may allow for multiple uses for either existing or new cards tied to this system.

This system may be tied to a single store, a single brand of gasoline retailer or marketer or it may be offered and accepted at multiple brands of retailers. The card and the system may be used at one station, at stations in one area such as city, state or region of the country or it may be used for stations nationally or internationally. It may also be offered by retailers or resellers who have no gasoline operations. However, the consumer knows beforehand, at the time of the initial purchase, where the medium is to be used to receive gasoline.

This method may also be developed into a system where the information tied to a card or one account is transmitted in a manner that does not require a card itself. Amongst others, it could include a bar code sticker placed on a card which is then scanned, an electronically enhanced keyring that communicates with radio waves, fingerprints, retina scans or mobile telephones and/or PDAs.

This system can be used for sale both at the retail level and the wholesale level. It can be sold in single units or in quantity.

This system may include the ability to purchase gallons of gasoline on the Internet. It may also allow cardholders to access their account information (or card information) on line, viewing the card's value, history, status and other pieces of information.

Retailers or sellers of the cards may choose to allow customers to receive a refund for the card if they choose. This refund would be at the price originally paid or it could be converted into the like dollar amount that the customer could use for other merchandise or services.

A preferred cash flow process begins with the card purchase. A customer goes into a station and buys a number of gallons at a certain grade or grades of gasoline for a price per gallon. The retailer receives the purchase price and enables a card. A wholesaler or third party creates an account tied to the card from which account redemptions are paid.

At settlement the retailer forwards money to the wholesaler or third party and may keep a transaction cost. The retailer pays a credit card issuer for the wholesaler or third party card purchase transaction. The retailer may then pay a transaction processor for the transaction. The retailer could have a retainable amount of money associated with the card sale. The wholesaler or third party then creates an account tied to the card from which redemptions are paid or an account in aggregate.

A preferred redemption cash flow process begins with the customer swiping the card at a station. The retail system transmits card number and price per gallon for the appropriate gasoline grade to wholesaler or third party. They in turn access the card account data, verifies the number of gallons remaining on card, calculates the value of authorization by multiplying the number of gallons available by the price per gallon and authorizes at the price per gallon. The customer then pumps the number of gallons. Then at settlement the wholesaler or third party pays the retailer an amount reflecting the monetary amount minus a transaction fee.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A prepaid gallon-based gasoline system, comprising:
a medium including readable data,
a reader operable to read the readable data, and
a computer system operable to analyze the readable data and identify a remaining amount of gallons of gasoline associated with the readable data, the computer system operatively identifying a distributed amount of gallons of gasoline distributed to a consumer during one use,
wherein the computer system decrements the remaining amount of gallons of gasoline associated with the readable data by the distributed amount of gallons of gasoline, the prepaid amount of gallons being purchased at a predetermined price.

2. The prepaid gallon-based gasoline system according to claim 1, wherein the medium is one of a card, a magnetic strip, a barcode strip, and electronic chip, a radio-wave readable medium, fingerprints, retina, PDA, and mobile telephone.

3. A method of purchasing gasoline, comprising:
purchasing a number of gallons of gasoline based on a predetermined price,
associating a medium having readable data with the number of gallons purchased, the medium being readable by a reader to identify the readable data, and
storing data related to the purchase in a computer system so that the readable data identifies the number of gallons of gasoline purchased and allows an amount of gasoline to be dispensed when the medium is used to acquire gasoline, the computer system operable to subtract the amount of gasoline dispensed in gallons from the number of gallons of gasoline purchased and newly associate the readable data or rewrite the readable data to reflect the subtraction.

4. A method of selling gasoline, comprising:
reading a medium having readable data via a reader,
identifying the readable data from a database via a computer system,
associating a number of gallons of gasoline with the readable data, the number of gallons being pre-purchased at a predetermined price,
dispensing an amount of gasoline to a consumer,
associating the amount of gasoline dispensed with the readable data,
subtracting the amount of gasoline dispensed from the number of gallons which are pre-purchased to obtain a new number of gallons of gasoline, and
associating the a new number with the readable data or rewriting the readable data to reflect the a new number.

5. A method of selling gasoline, whereby a consumer prepurchases for a finite number of gallons of gasoline at a predetermined price, and immediately receives a card which reflects, facilitates and tracks the transaction; comprising:
redeeming, the gallons of gasoline over a specified time after the prepurchase has occurred, wherein the consumer purchases the card at a retail establishment at which the gallons of gasoline may be redeemed.
